(19) United States
(12) Patent Application Publication
(10) Pub. No.: US 2002/0196580 A1
(43) Pub. Date: Dec. 26, 2002

(54) Magnetic disk drive and disk cartridge

(76) Inventors: Nobuhiko Tsukahara, Kanagawa (JP); Takehisa Ishida, Tokyo (JP)

Correspondence Address: JAY H. MAIOLI, Cooper & Dunham LLP, 1185 Avenue of the Americas, New York, NY, 10036, US

(21) Appl. No.: 10/162,029

(22) Filed: Jun. 3, 2002

(30) Foreign Application Priority Data
Jun. 5, 2001 (JP) P2001-170325

(51) Int. Cl. G11B 17/00

(52) U.S. Cl. 360/97.01

(57) ABSTRACT

In a cartridge type hard disk drive, a pair of yokes with magnets as a magnetic circuit for a voice coil motor are mounted in a cartridge holder separated from a disk cartridge. When the disk cartridge is inserted into the cartridge holder, a movable coil for the voice coil motor is placed in a magnetic field formed by the magnetic circuit in the cartridge holder. In this condition, a drive current is passed through the movable coil, thereby driving a head arm actuator. With this configuration, the disk cartridge in the cartridge type hard disk drive can be reduced in size and weight. In addition, a further cost reduction and resource saving can also be realized.

### BACKGROUND OF THE INVENTION

The present invention relates to a magnetic disk drive such as a hard disk drive, and more particularly to a cartridge type magnetic disk drive having a structure that a mechanical unit including a disk can be separated from at least a circuit board for replacement, and also to a disk cartridge for use in such a cartridge type magnetic disk drive.

Known as a recent hard disk drive (which will be hereinafter referred to as HDD) detachably mounted into a device bay formed in the body of a host unit such as a personal computer is a cartridge type HDD consisting of a disk cartridge and a cartridge holder. The disk cartridge is configured by a mechanical unit including a disk, a disk driving mechanism, and a head arm actuator. The cartridge holder includes a main circuit board, and it is fixed to the device bay in the body of the host unit. That is, the mechanical unit is separated from the main circuit board. The disk cartridge is detachably mounted into the cartridge holder.

In general, it is known that the product life of an HDD is substantially determined by the life of a mechanical unit in the HDD. Accordingly, by arranging only the mechanical unit in the HDD separated from the remaining part and making only the disk cartridge including the mechanical unit replaceable, the number of parts to be replaced can be reduced to thereby reduce a cost required for replacement of the HDD. Further, resource saving can also be realized. Such a cartridge type HDD is known from Japanese Patent Laid-open No. 2001-084734, for example.

As described above, the cartridge type HDD has an advantage such that only the mechanical unit substantially determining the product life of the HDD is separately provided as a disk cartridge, so that only the disk cartridge can be replaced as required in case of trouble, thereby allowing minimization of parts replacement and resource saving. However, in the conventional design concept as described in Japanese Patent Laid-open No. 2001-084734, only the circuit board is merely separated from the disk cartridge as a mechanical unit, and the effects of minimization of parts replacement and resource saving as obtained by the cartridge configuration is therefore limited.

### SUMMARY OF THE INVENTION

It is accordingly an object of the present invention to provide a disk cartridge which can be further reduced in size and weight to realize a further cost reduction and resource saving. It is another object of the present invention to provide a magnetic disk drive using such a disk cartridge. It is a further object of the present invention to provide a magnetic disk drive and a disk cartridge which can amplify the effects obtained by the cartridge type, by separating a voice coil motor into a magnetic circuit as a fixed portion and a coil as a movable portion.

According to an aspect of the present invention, there is provided a magnetic disk drive including a cartridge holder having a magnetic circuit for a voice coil motor and mountable into a host unit; and a disk cartridge adapted to be detachably inserted in the cartridge holder. The disk cartridge includes a disk driving mechanism for supporting and driving a magnetic disk; a head moving mechanism having a magnetic head for recording a signal to the magnetic disk and reproducing a signal from the magnetic disk, movably supporting the magnetic head in a radial direction of the magnetic disk; and a movable coil cooperating with the magnetic circuit in the cartridge holder for the voice coil motor when the disk cartridge is inserted in the cartridge holder to generate a force of operating the head moving mechanism.

Preferably, the cartridge holder further includes a main circuit board, and the disk cartridge further includes a connector for making electrical connection with the main circuit board when the disk cartridge is inserted in the cartridge holder.

Preferably, the magnetic circuit in the cartridge holder includes a pair of first and second magnets arranged so as to interpose the movable coil in the disk cartridge in a direction substantially perpendicular to a direction of movement of the movable coil when the disk cartridge is inserted in the cartridge holder, and a pair of first and second yokes to which the pair of first and second magnets are fixed, respectively.

Thus, the magnetic circuit for the voice coil motor as configured by magnets and yokes is mounted in the cartridge holder separated from the disk cartridge as a mechanical unit. With this configuration, the number of parts of the disk cartridge can be reduced, resulting in size reduction and weight reduction. Further, a further cost reduction and resource saving on the disk cartridge can be realized.

Other objects and features of the invention will be more fully understood from the following detailed description and appended claims when taken with the accompanying drawings.

### BRIEF DESCRIPTION OF THE DRAWINGS

FIG. 1 is a perspective view of a cartridge type magnetic disk drive according to a preferred embodiment of the present invention in the condition where a disk cartridge is ejected from a cartridge holder;

FIG. 2 is a perspective view of the magnetic disk drive according to the preferred embodiment of the present invention in the condition where the disk cartridge is inserted in the cartridge holder;

FIG. 3 is an exploded perspective view of the disk cartridge of a cartridge type magnetic disk drive according to the preferred embodiment of the present invention;

FIG. 4 is a plan view of the disk cartridge shown in FIG. 3 with a top cover removed;

FIG. 5 is a sectional view of the disk cartridge shown in FIG. 3;

FIGS. 6A and 6B are sectional views for illustrating a separatable structure of a voice coil motor in the disk cartridge shown in FIG. 3;

FIG. 7 is a sectional view showing the configuration of a head arm actuator in the disk cartridge shown in FIG. 3;

FIG. 8 is a plan view showing the configuration of a head arm mounted on the head arm actuator shown in FIG. 7;

FIG. 9 is a sectional view showing the configuration of a disk driving mechanism in the disk cartridge shown in FIG. 3;

FIG. 10 is a sectional view for illustrating the connection of a connector module in the disk cartridge shown in FIG. 3;

FIG. 11 is a plan view showing adapters each having a sealing function which are adapted to be mounted on the opposite side surfaces of a cartridge housing;

FIG. 12 is a plan view showing a condition where the adapters are mounted on the cartridge housing;

FIGS. 13A and 13B are plan views for illustrating an effect of reduction in width of the disk cartridge by the adapters; and

FIG. 14 is a block diagram showing a circuit configuration of the cartridge type magnetic disk drive according to the preferred embodiment of the present invention.

### DETAILED DESCRIPTION OF THE PREFERRED EMBODIMENTS

A preferred embodiment of the present invention will now be described in detail with reference to the drawings.

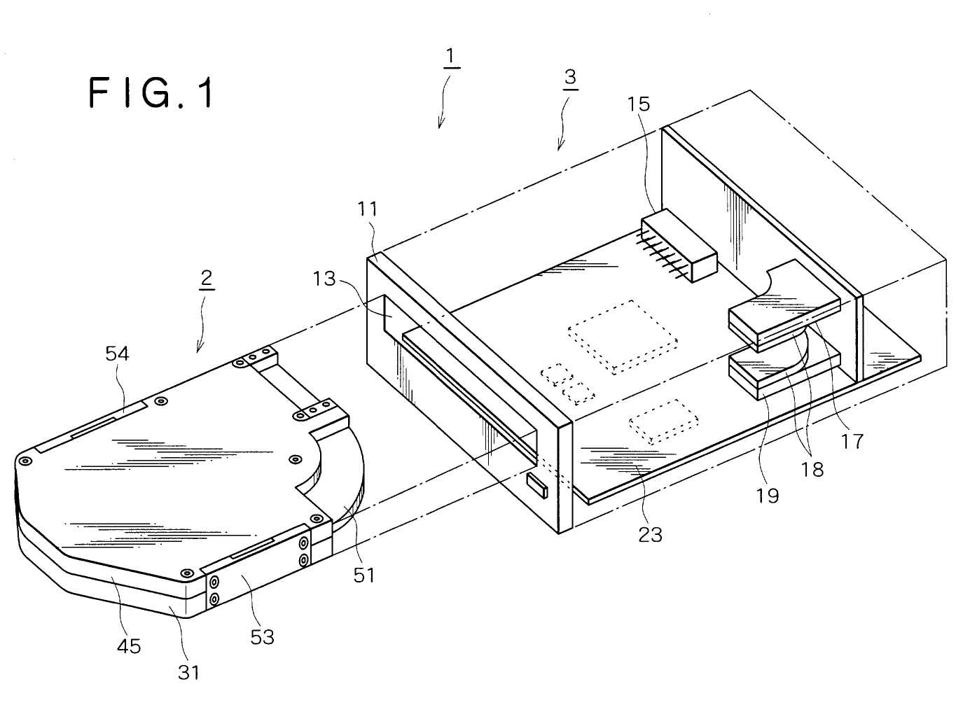

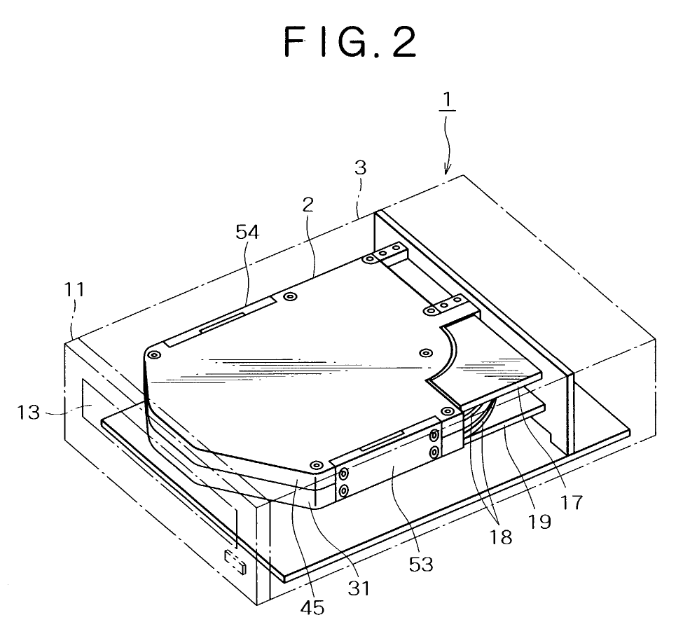

FIGS. 1 and 2 are perspective views showing the general configuration of a cartridge type magnetic disk drive 1 according to a preferred embodiment of the present invention.

As shown in FIGS. 1 and 2, the magnetic disk drive 1 is composed generally of a disk cartridge 2 and a cartridge holder 3 adapted to accommodate the disk cartridge 2.

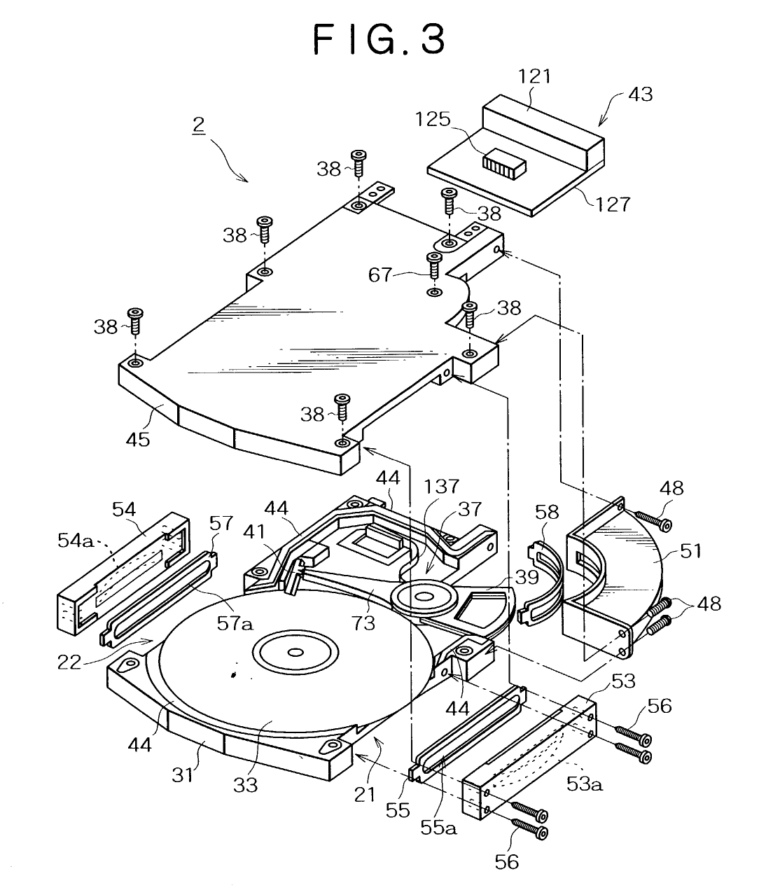

The disk cartridge 2 includes a magnetic disk (which will be hereinafter referred to simply as disk) 33 (see FIG. 3), a disk driving mechanism for rotationally driving the disk 33, a head arm actuator 37 (see FIG. 3) for supporting a magnetic head and moving it in the radial direction of the disk 33, and a part of a voice coil motor for driving the head arm actuator 37 except a magnetic circuit. The disk 33 employs a plastic substrate as a base substrate. However, any other materials such as glass may be used as the material of the base substrate.

The cartridge holder 3 includes connectors for making electrical connections to the disk cartridge 2 and to a host unit (not shown), a circuit board 23 having various functional circuits for controlling motors and the magnetic head, processing data, processing input/output of data with respect to the host unit, etc., and the magnetic circuit of the voice coil motor which drives the head arm actuator 37.

1. Details of Cartridge Holder 3

The cartridge holder 3 is mountable in a 3.5-inch device bay formed in the body of the host unit such as a personal computer. The cartridge holder 3 has an external connector (not shown) adapted to be connected to a signal line connecting portion provided in the body of the host unit, and a power supply connector (not shown) adapted to be connected to a power supply connecting portion provided in the body of the host unit.

The cartridge holder 3 has a front panel 11 formed of resin. The front panel 11 is exposed to the front side of the body of the host unit in the condition where the cartridge holder 3 is inserted in the device bay of the host unit The front panel 11 is formed with a cartridge insertion opening 13 for allowing insertion and ejection of the disk cartridge 2.

An internal connector 15 is provided inside the cartridge holder 3 to make electrical connection to the disk cartridge 2 for signal transmission and power supply. Further, a top yoke 17 and a bottom yoke 19 each constituting the magnetic circuit of the voice coil motor are provided inside the cartridge holder 3 so as to be opposed to each other. A pair of magnets 18 are bonded to the opposed surfaces of the top yoke 17 and the bottom yoke 19.

The circuit board 23 is detachably mounted on the bottom of the cartridge holder 3 by means of screws (not shown).

2. Details of Disk Cartridge 2

2.1 General Configuration

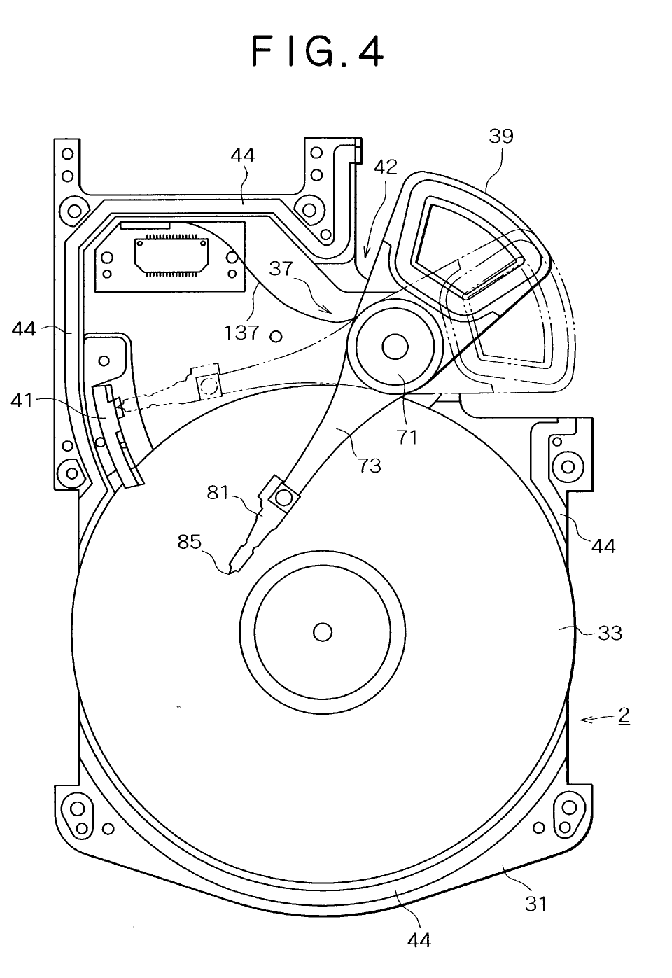

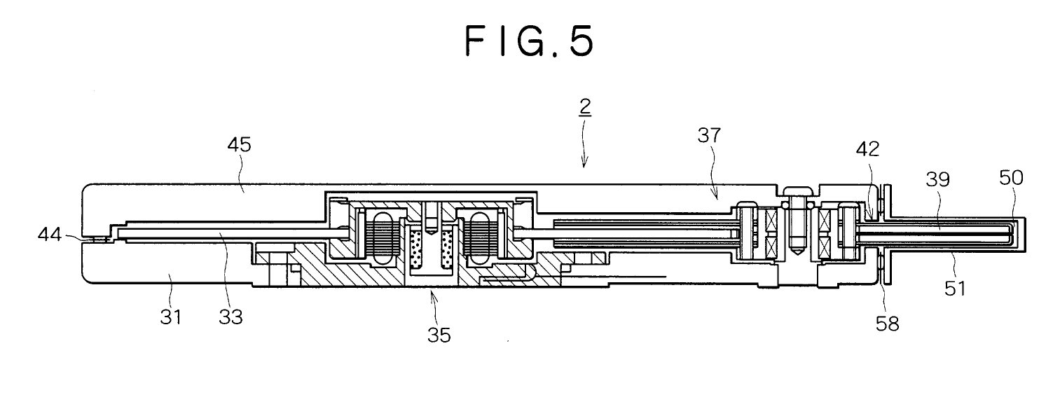

FIG. 3 is an exploded perspective view of the disk cartridge 2, FIG. 4 is a plan view of the disk cartridge 2 with a top cover 45 removed, and FIG. 5 is a sectional view of the disk cartridge 2.

Reference numeral 31 denotes a chassis formed of aluminum as the base of the disk cartridge 2. Mounted on the upper surface of the chassis 31 are various mechanical components including a spindle motor (SPM) 35 as the disk driving mechanism to which the disk 33 is fixed to rotationally drive the disk 33, the head arm actuator 37 for supporting the magnetic head such as a GMR head, a movable coil 39 as a component of the voice coil motor for moving the head arm actuator 37 in the radial direction of the disk 33, and a ramp (inclined path) load mechanism 41.

The upper surface of the chassis 31 as the mechanical component mounting surface is covered with the top cover 45 formed of aluminum. The top cover 45 is fixed to the chassis 31 by any fastening means, e.g., a plurality of screws 38 as shown. The chassis 31 and the top cover 45 are so designed as to be fitted with each other at their outer peripheral portions except one part, and sealing members 44 formed of fluororubber or the like are interposed between the opposed surfaces of the outer peripheral portions of the chassis 31 and the top cover 45. The combination of the chassis 31 and the top cover 45 will be hereinafter referred to as “cartridge housing”.

A connector module 43 for making electrical connection between the internal connector 15 of the cartridge holder 3 and the disk cartridge 2 is mounted on the lower surface of the chassis 31.

The side wall of the cartridge housing is partially opened at an opening portion 42 to project the movable coil 39 of the voice coil motor therefrom. A coil cover 51 having an internal space 50 for allowing rotation of the movable coil 39 projecting from the opening portion 42 is fixed through a packing member 58 formed of fluororubber or the like to the opening portion 42 by any fastening means, e.g., a plurality of screws 48 as shown. The thickness of the coil cover 51 is smaller than that of the disk cartridge 2, and is set so that optimum spacings are ensured between the coil cover 51 and the magnet 18 of the top yoke 17 fixed to the cartridge holder 3, between the coil cover 51 and the magnet 18 of the bottom yoke 19 fixed to the cartridge holder 3, and between the coil cover 51 and the movable coil 39.

The opposite side surfaces of the cartridge housing on its longer sides are formed with a pair of laterally symmetrical recessed portions 21 and 22 for allowing projection of the disk 33 at its radially opposite end portions. A pair of adapters 53 and 54 are fixed through packing members 55 and 57 to the recessed portions 21 and 22, respectively, by any fastening means, e.g., a plurality of screws 56 as shown. The adapters 53 and 54 are formed with concave portions 53a and 54a, respectively, so as to avoid interference with the disk 33 projecting into the recessed portions 21 and 22. The adapters 53 and 54 are just fitted with the recessed portions 21 and 22, respectively, so that the outer side surfaces of the adapters 53 and 54 become flush with the opposite side surfaces of the cartridge housing of the disk cartridge 2. With this configuration, the adapters 53 and 54 contribute to a reduction in width of the cartridge housing as a whole.

The chassis 31, the top cover 45, the coil cover 51, and the adapters 53 and 54 constitute a hermetic case of the disk cartridge 2 as a whole. The internal space of the hermetic case is maintained preferably in a dry atmosphere with at least moisture eliminated, more preferably in a dry atmosphere of inert gas such as dry nitrogen gas.

2.2 Separatable Structure of Voice Coil Motor

In this preferred embodiment, the magnets 18 and the yokes 17 and 19 as the magnetic circuit of the voice coil motor are provided on the cartridge holder 3 side, and these members 17, 18, and 19 are separated from the movable portion of the voice coil motor on the disk cartridge 2 side.

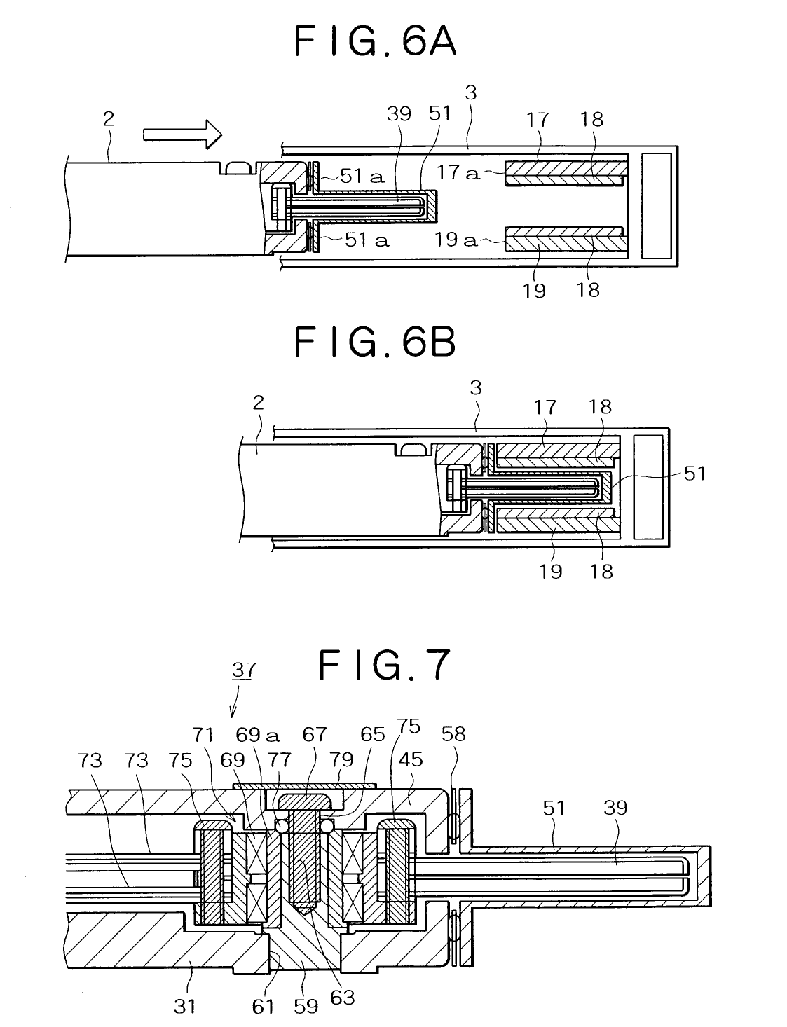

When the disk cartridge 2 is inserted into the cartridge holder 3 as shown in FIGS. 6A and 6B, the coil cover 51 covering the movable coil 39 of the voice coil motor and mounted on the disk cartridge 2 is inserted between the magnets 18 of the yokes 17 and 19 fixedly mounted in the cartridge holder 3.

The disk cartridge 2 is inserted into the cartridge holder 3 until side wall surfaces 51a of the coil cover 51 abut against front ends 17a and 19a of the top and bottom yokes 17 and 19.

In such a fully inserted condition of the disk cartridge 2 in the cartridge holder 3, the movable coil 39 of the voice coil motor is placed in a magnetic field formed by the magnetic circuit in the cartridge holder 3. When a drive current is passed through the movable coil 39 in this condition, the head arm actuator 37 is driven by the voice coil motor.

2.3 Configuration of Head Arm Actuator 37

FIG. 7 shows the configuration of the head arm actuator 37.

As shown in FIG. 7, the chassis 31 has a hole 61 in which a support shaft 59 for the head arm actuator 37 rotatable by the voice coil motor is fixed at one end portion by press fit. The other end portion of the support shaft 59 is formed with a tapped hole 63 opening to the upper end surface of the support shaft 59. The top cover 45 is formed with a through hole 65 aligned with the tapped hole 63 of the support shaft 59. A screw 67 is inserted through the through hole 65 of the top cover 45 and is threadedly engaged with the tapped hole 63 of the support shaft 59, thereby fixing the other end of the support shaft 59 to the top cover 45.

A pivot 71 as a rotary shaft of the head arm actuator 37 is rotatably mounted on the support shaft 59 through a bearing portion 69. The movable coil 39 of the voice coil motor and a pair of head arms 73 are fixedly mounted on the pivot 71 by any fastening means, e.g., a plurality of screws 75 as shown.

A gap is defined between the lower surface of the top cover 45 at a portion around the through hole 65 and the upper end surface of the support shaft 59 around the tapped hole 63, and a sealing member 77 such as an O-ring is fitted in this gap. An inner ring 69a of the bearing portion 69 is fixedly mounted on the support shaft 59, and the upper end surface of the inner ring 69a abuts against the lower surface of the top cover 45 at a portion around the above gap. Thus, the abutment portion between the upper end surface of the inner ring 69a of the bearing portion 69 and the lower surface of the top cover 45 around the above gap is hermetically sealed with the sealing member 77 from the inside of the disk cartridge 2. Further, the through hole 65 of the top cover 45 is sealed at its upper end with a sheetlike sealing member 79.

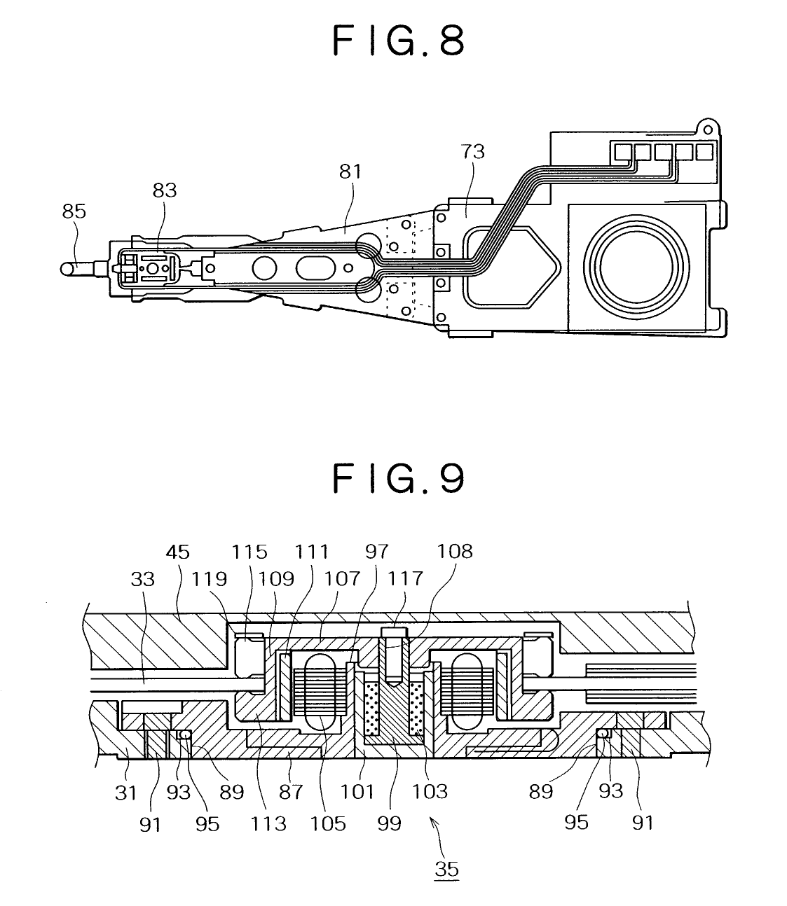

As shown in FIG. 8, a suspension 81 is mounted on each head arm 73 at its front end portion, and a slider 83 having the magnetic head is mounted on each suspension 81 at its front end portion. Each suspension 81 functions as a spring for biasing the corresponding slider 83 toward the surface of the disk 33 opposed to the corresponding slider 83. A tab 85 adapted to slide on a dynamic loading/unloading ramp of the ramp load mechanism 41 is provided at the front end of each suspension 81. The ramp load mechanism 41 is a mechanism for protecting the magnetic head in an area where the magnetic head does not come into contact with the surface of the disk 33 in an inoperative condition of the magnetic head. This mechanism 41 is located outside of the outermost track on the disk 33.

2.4 Configuration of Disk Driving Mechanism

FIG. 9 shows the configuration of the disk driving mechanism. The chassis 31 is formed with a hole 89 in which a stator 87 of the spindle motor 35 is fitted. The stator 87 fitted in the hole 89 is fixed to the chassis 31 by any fastening means, e.g., a plurality of screws 91 as shown. The inner wall of the hole 89 in which the stator 87 of the chassis 31 is fitted is formed with a stepped portion 93. A sealing member 95 such as an O-ring for sealing a gap between the chassis 31 and the stator 87 is provided on the stepped portion 93.

The stator 87 is coaxially formed at its central portion with a cylindrical portion 97, and a rotating shaft 99 is rotatably supported within the cylindrical portion 97 of the stator 87 by a hydrodynamic bearing 101. The hydrodynamic bearing 101 includes an outer case and a viscous fluid (e.g., oil) 103 compressed between the outer circumferential surface of the rotating shaft 99 and the inner circumferential surface of the outer case, wherein the rotating shaft 99 is rotatably supported by a pressure (dynamic pressure) due to the compression of the viscous fluid 103. A stator coil 105 is mounted on the outer circumferential surface of the cylindrical portion 97 of the stator 87.

A rotor 107 is fixed to the rotating shaft 99. More specifically, the rotor 107 has a central hole 108, and the rotating shaft 99 is inserted in the central hole 108 of the rotor 107. The rotor 107 is coaxially formed at its outer circumferential portion with a cylindrical portion 109. A ringlike magnet 111 is mounted on the inner circumferential surface of the cylindrical portion 109 of the rotor 107 so as to be opposed to the stator coil 105 mounted on the outer circumferential surface of the cylindrical portion 97 of the stator 87.

The cylindrical portion 109 of the rotor 107 is formed at its lower end with a flange 113. A ringlike disk clamp 115 is fitted with the outer circumferential surface of the cylindrical portion 109 of the rotor 107 so as to be axially opposed to the flange 113. The disk 33 has a center hole fitted with the outer circumferential surface of the cylindrical portion 109 of the rotor 107, and a peripheral portion about the center hole of the disk 33 is clamped between the lower end surface of the disk clamp 115 and the upper end surface of the flange 113. The rotor 107 and the disk clamp 115 are pressed down by a disklike plate 119 fixed to the rotating shaft 99 by means of a screw 117.

2.5 Structure of Connector Module 43

As mentioned above with reference to FIG. 3, the connector module 43 for making electrical connection between the internal connector 15 in the cartridge holder 3 and the disk cartridge 2 is mounted on the lower surface of the chassis 31.

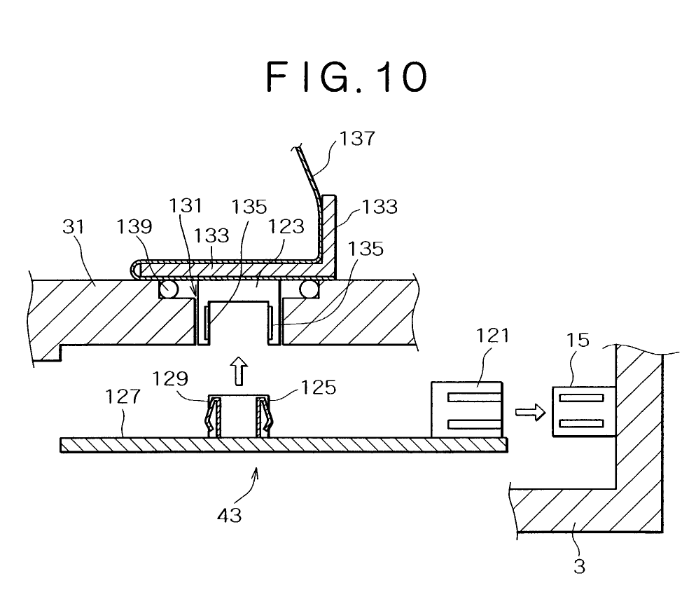

FIG. 10 shows a manner of connection of the connector module 43. The connector module 43 includes a connector 121 adapted to be connected to the pin type internal connector 15 in the cartridge holder 3 and a bellows contact type connector head 125 adapted to be fitted into a socket 123 fixed to the chassis 31. The bellows contact is a contact formed by bending a leaf spring, and it has a structure such that a bent surface of the leaf spring comes into contact. The connector head 125 has side surfaces substantially perpendicular to the upper surface of a module substrate 127, and a plurality of bellows contacts 129 are arranged in parallel on each side surface of the connector head 125.

The chassis 31 is formed with a hole 131, and a socket 123 mounted on a flexible board 137 is fitted in the hole 131 of the chassis 31. A plurality of contacts 135 are arranged in parallel on each inner wall surface of the socket 123. The contacts 135 of the socket 123 are adapted to come into contact with the bellows contacts 129 of the connector head 125. The flexible board 137 is fixed at its one end portion to an L-shaped reinforcing plate 133 fixed to the upper surface of the chassis 31. The flexible board 137 extends from a vertical portion of the L-shaped reinforcing plate 133, and the other end portion of the flexible board 137 is connected to the movable coil 39 of the voice coil motor and the magnetic heads supported by the pair of head arms 73 of the head arm actuator 37.

A sealing member 139 such as an O-ring is provided between the reinforcing plate 133 and the chassis 31 to seal a gap therebetween.

2.6 Hermetic Structure of Disk Cartridge 2

In general, a hard disk drive is provided with a breather hole for supporting a change in air pressure. In contrast thereto, the disk cartridge 2 in this preferred embodiment has no breather hole, but adopts the following sealing structure for realizing an improved hermetic seal of the interior of the disk cartridge 2, so as to maintain the atmosphere in the disk cartridge 2 in a moisture-free inert gas atmosphere such as a dry nitrogen gas atmosphere.

(1) The gap between the chassis 31 and the top cover 45, the gap between the cartridge housing and the coil cover 51, the gap between the cartridge housing and the adapter 53, and the gap between the cartridge housing and the adapter 54 are sealed with the sealing members 44, 58, 55 and 57.

(2) The gap at the abutment portion between the upper end surface of the inner ring 69a of the bearing portion 69 in the head arm actuator 37 and the lower surface of the top cover 45 is sealed with the sealing member 77 such as an O-ring.

(3) The gap between the reinforcing plate 133 and the chassis 31 is sealed with the sealing member 139 such as an O-ring.

(4) All the through holes formed through the top cover 45 for insertion of the screws are sealed with the sheetlike sealing members 79.

(5) The sealing member 95 such as an O-ring for sealing the gap between the chassis 31 and the stator 87 is provided at the shoulder portion formed on the inner circumference of the hole of the chassis 31 for engagement of the stator 87 of the spindle motor 35.

2.7 Reduction in Cartridge Width by Adapters 53 and 54

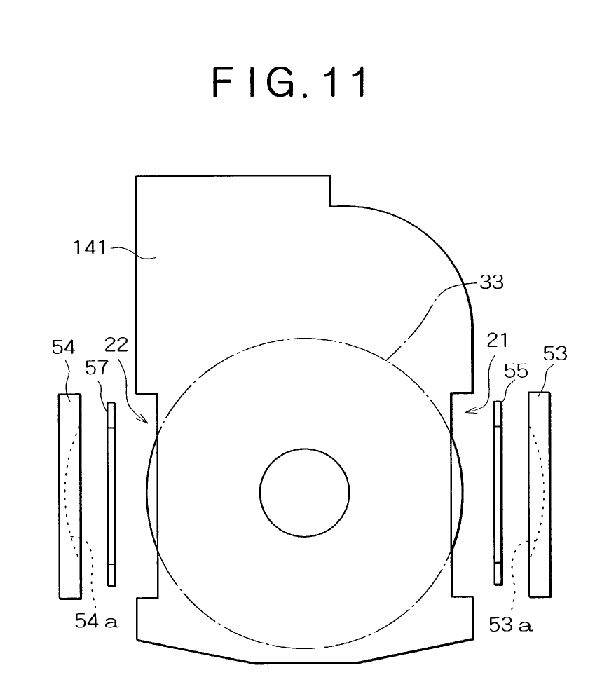

As shown in FIG. 11, the laterally symmetrical recessed portions 21 and 22 into which the radially opposite end portions of the disk 33 project are formed on the opposite side surfaces of the cartridge housing 141, and the adapters 53 and 54 having the respective concave portions 53a and 54a for avoiding the interference with the disk 33 are fixed through the packing members 55 and 57 to the recessed portions 21 and 22, respectively, by any fastening means, e.g., the screws 56 shown in FIG. 3.

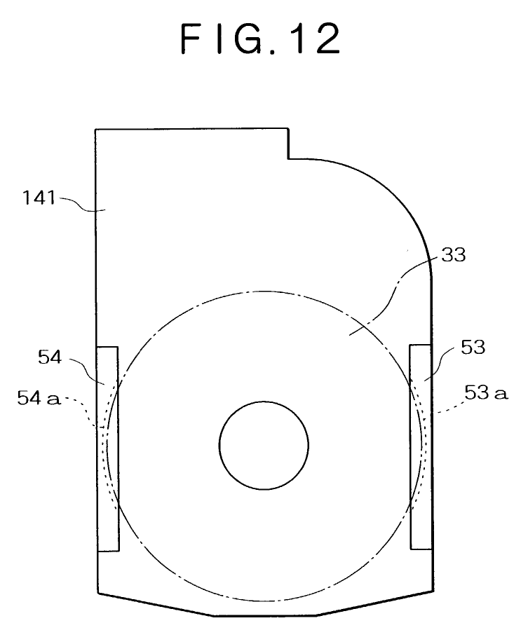

As shown in FIG. 12, the recessed portions 21 and 22 are filled with the adapters 53 and 54, respectively, thereby making the opposite side surfaces of the cartridge housing 141 flush with the outer side surfaces of the adapters 53 and 54.

The adapters 53 and 54 contribute to a reduction in width of the cartridge housing 141. The principle of this width reduction will now be described.

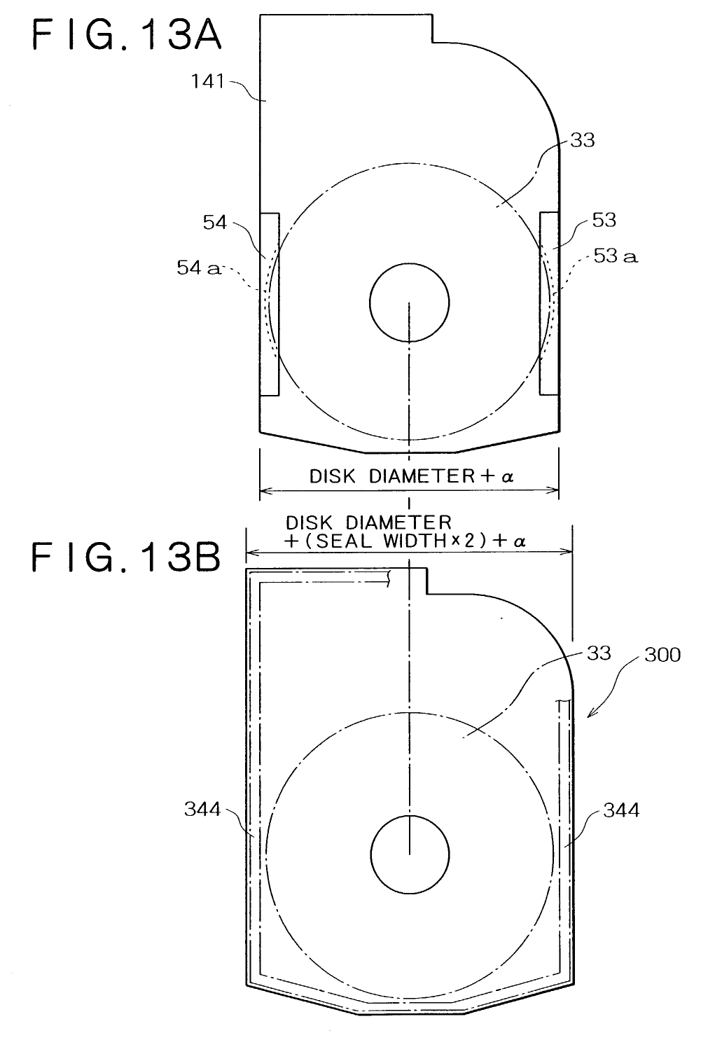

FIG. 13A shows the cartridge housing 141 according to this preferred embodiment, and FIG. 13B shows a cartridge housing 300 as a comparison. The cartridge housing 300 includes a chassis and a top cover fitted together with a sealing member 344 interposed therebetween. The sealing member 344 is located along the outer peripheral portions of the chassis and the top cover except a part for mounting a coil cover. The cartridge housing 300 shown in FIG. 13B is different from the cartridge housing 141 shown in FIG. 13A in the point that the recessed portions 21 and 22 are not formed and that the sealing member 344 is located also near the laterally opposite ends of the disk 33. Accordingly, the cartridge housing 300 is required to have a minimum width equal to the diameter of the disk 33 +[(the width of the sealing member 344)×2]. In the case that the disk 33 is a disk having a diameter of 3.5 inches (95 mm), for example, and the sealing member 344 is required to have a minimum width of 3 mm, then the minimum width of the cartridge housing 300 in this case becomes 101 mm.

To the contrary, the sealing structure employing the adapters 53 and 54 with the packing members 55 and 57 according to this preferred embodiment can ensure a required seal width along the thickness of the disk cartridge 2, so that the required seal width has no influence upon the width of the disk cartridge 2. Further, the packing members 55 and 57 have openings 55a and 57a (see FIG. 3) for allowing insertion of the radially opposite end portions of the disk 33, respectively, and the adapters 53 and 54 have the recessed portions 53a and 54a for avoiding the interference with the outer circumference of the disk 33. Accordingly, the condition of determination of a distance from the outer circumference of the disk 33 to the side surface of the disk cartridge 2 on each side thereof can be relaxed, so that the width of the disk cartridge 2 can be reduced.

2.8 Circuit Configuration

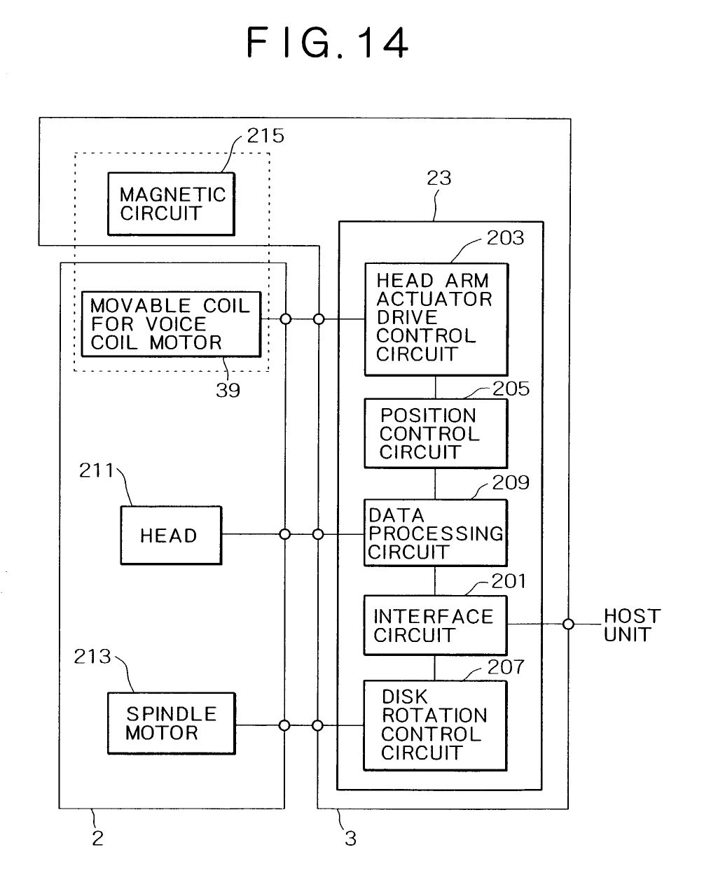

FIG. 14 is a block diagram showing a circuit configuration of the cartridge type magnetic disk drive according to this preferred embodiment.

As shown in FIG. 14, the circuit board 23 mounted in the cartridge holder 3 includes an interface circuit 201, a head arm actuator drive control circuit 203, a position control circuit 205, a disk rotation control circuit 207, and a data processing circuit 209.

The interface circuit 201 functions to exchange various control signals and data between the disk drive and the host unit.

The position control circuit 205 performs tracking servo for the head 211 according to a tracking error signal obtained from an output from the head 211. Further, the position control circuit 205 controls the position of the head 211 so that the head 211 reads from the disk 33 a signal corresponding to an address specified by the host unit or writes onto the disk 33 a signal corresponding to an address specified by the host unit.

The head arm actuator drive control circuit 203 supplies a drive signal to the movable coil 39 of the voice coil motor according to a position control signal from the position control circuit 205 to drive the head arm actuator 37.

The disk rotation control circuit 207 supplies a drive signal to the spindle motor 213 to control the operation of the spindle motor 213 to rotate it at a specific speed suitable for recording or reproduction.

The data processing circuit 209 modulates data transmitted from the host unit through the interface circuit 201 into a signal suitable for recording to the disk 33 to supply the obtained signal to the head 211, or demodulates a signal read from the disk 33 by the head 211.

The head arm actuator drive control circuit 203, the disk rotation control circuit 207 and the data processing circuit 209 are connected through the internal connector 15 of the cartridge holder 3 and the connector module 43 of the disk cartridge 2 to the movable coil 39 of the voice coil motor, the spindle motor 213, and the head 211, respectively.

Further, the cartridge holder 3 includes a magnetic circuit 215 (the top yoke 17 with the magnet 18 and the bottom yoke 19 with the magnet 18) as a part of the voice coil motor.

The circuit board 23 having above-described circuits mounted thereon is detachably mounted by screws or the like in the cartridge holder 3, so that the circuit board 23 can be removed from the cartridge holder 3 for the purpose of replacement with another board.

The magnetic disk drive 1 having the above configuration is assembled in the following manner. When the disk cartridge 2 is inserted into the cartridge holder 3 from the cartridge insertion opening 13 of the front panel 11 of the cartridge holder 3, the connector 121 of the connector module 43 of the disk cartridge 2 is connected to the internal connector 15 of the cartridge holder 3, and the coil cover 51 of the disk cartridge 2 for covering the movable coil 39 of the voice coil motor is inserted between the magnet 18 of the top yoke 17 and the magnet 18 of the bottom yoke 19.

In this condition, the spindle motor 35, the movable coil 39 of the voice coil motor, and the magnetic heads each mounted in the disk cartridge 2 are electrically connected with the circuit board 23 mounted in the cartridge holder 3, and the movable coil 39 of the voice coil motor is placed in the magnetic field formed by the magnetic circuit in the cartridge holder 3. Thus, the disk 33 can be driven, the head arm actuator 37 can be driven, and the head can be operated.

As described above, the magnetic disk drive 1 according to this preferred embodiment can exhibit the following effects.

The yokes 17 and 19 with the magnets 18 as the magnetic circuit of the voice coil motor are mounted in the cartridge holder 3 separated from the disk cartridge 2, thereby allowing a reduction in number of parts of the disk cartridge 2. Accordingly, the disk cartridge 2 can be reduced in size and weight. Further, a further cost reduction and resource saving on the disk cartridge 2 can be realized.

The magnetic disk drive 1 has an excellent hermetic structure capable of preventing the entry of dust or the like from the outside, thereby preventing head crash. Furthermore, the hermetically sealed space inside the disk cartridge 2 is filled with a dry atmosphere with at least moisture removed, preferably, a dry inert gas atmosphere such as a dry nitrogen gas atmosphere. Accordingly, the decomposition of lubricant applied to the disk surface and the oxidation of the other components inside the disk cartridge 2 can be prevented to thereby extend the life of the disk drive.

Further, the internal space in the disk cartridge 2 is hermetically sealed under a substantially atmospheric pressure, so that there is no possibility of leakage of the oil vaporized from the oil reservoir of the hydrodynamic bearing 101 in the disk driving mechanism. Accordingly, the vaporization of the oil from the oil reservoir of the hydrodynamic bearing 101 continues only for a short period of time until the pressure inside the disk cartridge 2 reaches a saturated vapor pressure of the oil, and the amount of the oil in the oil reservoir is selected in consideration of such a slight amount of oil vapor, thereby preventing the break of the bearing 101 due to lack of oil. As a result, a further extension of the life of the disk drive can be expected.

While the invention has been described with reference to specific embodiments, the description is illustrative and is not to be construed as limiting the scope of the invention. Various modifications and changes may occur to those skilled in the art without departing from the spirit and scope of the invention as defined by the appended claims.

What is claimed is:

1. A magnetic disk drive comprising:
a cartridge holder having a magnetic circuit for a voice coil motor and mountable into a host unit; and
a disk cartridge adapted to be detachably inserted in said cartridge holder;
wherein said disk cartridge includes:
a disk driving mechanism for supporting and driving a magnetic disk;
a head moving mechanism having a magnetic head for recording a signal to said magnetic disk and reproducing a signal from said magnetic disk, for movably supporting said magnetic head in a radial direction of said magnetic disk; and
a movable coil cooperating with said magnetic circuit in said cartridge holder for said voice coil motor when said disk cartridge is inserted in said cartridge holder to generate a force of operating said head moving mechanism.

2. A magnetic disk drive according to claim 1,
wherein said cartridge holder further includes a main circuit board, and said disk cartridge further includes a connector for making electrical connection with said main circuit board when said disk cartridge is inserted in said cartridge holder.

3. A magnetic disk drive according to claim 1,
wherein said magnetic circuit in said cartridge holder includes a pair of first and second magnets arranged so as to interpose said movable coil in said disk cartridge in a direction substantially perpendicular to a direction of movement of said movable coil when said disk cartridge is inserted in said cartridge holder and a pair of first and second yokes to which said pair of first and second magnets are fixed, respectively.

4. A magnetic disk drive according to claim 1,
wherein said magnetic disk in said disk cartridge is a hard disk.

5. A magnetic disk drive according to claim 4,
wherein said disk driving mechanism in said disk cartridge includes a fluid bearing.

6. A magnetic disk drive according to claim 5,
wherein said disk cartridge has a hermetic structure.

7. A magnetic disk drive according to claim 6,
wherein said disk cartridge is filled with inert gas having an atmospheric pressure.

8. A disk cartridge adapted to be detachably inserted in a cartridge holder having a magnetic circuit for a voice coil motor and mountable into a host unit, said disk cartridge comprising:
a disk driving mechanism for supporting and driving a magnetic disk;
a head moving mechanism having a magnetic head for recording a signal to said magnetic disk and reproducing a signal from said magnetic disk, for movably supporting said magnetic head in a radial direction of said magnetic disk; and
a movable coil cooperating with said magnetic circuit in said cartridge holder for said voice coil motor when said disk cartridge is inserted in said cartridge holder to generate a force of operating said head moving mechanism.

9. A disk cartridge according to claim 8, wherein said cartridge holder further includes a main circuit board, and said disk cartridge further includes a connector for making electrical connection with said main circuit board when said disk cartridge is inserted in said cartridge holder.

10. A disk cartridge according to claim 8, wherein said magnetic disk in said disk cartridge is a hard disk.

11. A disk cartridge according to claim 10,
wherein said disk driving mechanism in said disk cartridge includes a fluid bearing.

12. A disk cartridge according to claim 11,
wherein said disk cartridge has a hermetic structure.

13. A disk cartridge according to claim 12,
wherein said disk cartridge is filled with inert gas having an atmospheric pressure.
